(19) United States
(12) Patent Application Publication
(10) Pub. No.: US 2026/0341266 A1
(43) Pub. Date: Oct. 29, 2026

(54) AUDIO DATA GENERATION METHOD, APPARATUS, DEVICE, STORAGE MEDIUM, AND PROGRAM PRODUCT

(71) Applicant: Beijing Zitiao Network Technology Co., Ltd., Beijing (CN)

(72) Inventors: Ciyuan YANG, Beijing (CN); Changqing HONG, Beijing (CN); Yilin SUN, Beijing (CN); Xiaomin LU, Beijing (CN); Kaiyang QU, Beijing (CN); Liangfeng DING, Beijing (CN); Xiaoqing WU, Beijing (CN)

(21) Appl. No.: 19/423,951

(22) Filed: Dec. 17, 2025

(30) Foreign Application Priority Data
Apr. 27, 2025 (CN) 202510542803.8

(51) Int. Cl. G10L 13/033; G10H 1/00; G10H 1/36; G10L 21/0208; G10L 21/0272

(52) U.S. Cl. CPC G10L 13/0335; G10H 1/0025; G10H 1/36; G10L 21/0208; G10L 21/0272; G10H 2210/005; G10H 2210/111; G10L 2021/02082

(57) ABSTRACT

There is disclosed an audio data generation method and apparatus, a device, a storage medium, and a program product, which relate to the technical field of audio processing. The method includes: acquiring original audio data, and separating vocal data and accompaniment data from the original audio data; performing separation processing on the vocal data to obtain a dry vocal corresponding to the vocal data; determining a target virtual object voice matching with the dry vocal based on a range of the dry vocal; performing denoising processing on the accompaniment data to obtain target accompaniment data; and performing mixing processing on the target virtual object voice and the target accompaniment data to generate target audio data.

### CROSS-REFERENCE TO RELATED APPLICATION

The present application is based on and claims priority to Chinese Patent Application No. 202510542803.8, and filed on Apr. 27, 2025, the entire disclosure of the Chinese Patent Application is hereby incorporated by reference in its entirety.

### TECHNICAL FIELD

The present disclosure relates to the technical field of audio processing, and in particular, to an audio data generation method and apparatus, a device, a storage medium, and a program product.

### BACKGROUND

As a product of a combination of artificial intelligence and computer technologies, Song Voice Conversion (SVC) music technology is used to generate artificially synthesized singing voices, and it mainly converts singing voice features of one person into singing voice features of another person while retaining information of the original song such as melody and rhythm.

### SUMMARY

In view of this, the present disclosure provides an audio data generation method and apparatus, a device, a storage medium, and a program product.

In a first aspect, the present disclosure provides an audio data generation method, including:
acquiring original audio data, and separating vocal data and accompaniment data from the original audio data;
performing separation processing on the vocal data to obtain a dry vocal corresponding to the vocal data;
determining a target virtual object voice matching with the dry vocal based on a range of the dry vocal;
performing denoising processing on the accompaniment data to obtain target accompaniment data; and
performing mixing processing on the target virtual object voice and the target accompaniment data to generate target audio data.

In a second aspect, the present disclosure provides an audio data generation apparatus, including:
an acquisition module, configured to acquire original audio data, and separate vocal data and accompaniment data from the original audio data;
a separation module, configured to perform separation processing on the vocal data to obtain a dry vocal corresponding to the vocal data;
a matching module, configured to determine a target virtual object voice matching with the dry vocal based on a range of the dry vocal;
a denoising module, configured to perform denoising processing on the accompaniment data to obtain target accompaniment data; and
a generation module, configured to perform mixing processing on the target virtual object voice and the target accompaniment data to generate target audio data.

In a third aspect, the present disclosure provides a computer device, including:
a memory and a processor, where the memory and the processor are communicatively connected to each other, the memory stores computer instructions, and the processor executes the computer instructions to perform the audio data generation method according to the first aspect or any implementation corresponding thereto.

In a fourth aspect, the present disclosure provides a computer-readable storage medium, where the computer-readable storage medium stores computer instructions, and the computer instructions are used to cause a computer to perform the audio data generation method according to the first aspect or any implementation corresponding thereto.

In a fifth aspect, the present disclosure provides a computer program product, including computer instructions, where the computer instructions are used to cause a computer to perform the audio data generation method according to the first aspect or any implementation corresponding thereto.

### BRIEF DESCRIPTION OF THE DRAWINGS

In order to more clearly explain the technical solutions in the specific embodiments of the present disclosure or in the related art, the following will briefly introduce the drawings that need to be used in the description of the specific embodiments or related art. Obviously, the drawings in the following description are some embodiments of the present disclosure. For those of ordinary skill in the art, other drawings may be derived from these drawings without paying creative effort.

FIG. 1 is a schematic flowchart of an audio data generation method according to an embodiment of the present disclosure;

FIG. 2 is a schematic diagram of separation of vocals and accompaniment according to an embodiment of the present disclosure;

FIG. 3 is a schematic flowchart of another audio data generation method according to an embodiment of the present disclosure;

FIG. 4 is a schematic diagram of selection of a virtual object voice according to an embodiment of the present disclosure;

FIG. 5 is a schematic flowchart of yet another audio data generation method according to an embodiment of the present disclosure;

FIG. 6 is a schematic diagram of mixing according to an embodiment of the present disclosure;

FIG. 7 is a schematic diagram of specific generation of audio data according to an embodiment of the present disclosure;

FIG. 8 is a structural block diagram of an audio data generation apparatus according to an embodiment of the present disclosure; and

FIG. 9 is a schematic structural diagram of hardware of a computer device according to an embodiment of the present disclosure.

### DETAILED DESCRIPTION OF EMBODIMENTS

In order to make the purposes, technical solutions and advantages of embodiments of the present disclosure clearer, the technical solutions in the embodiments of the present disclosure will be clearly and completely described below in combination with the drawings in the embodiments of the present disclosure. Obviously, the described embodiments are part of the embodiments of the present disclosure, but not all of the embodiments. Based on the embodiments in the present disclosure, all other embodiments obtained by those skilled in the art without paying creative work belong to the protection scope of the present disclosure.

It may be understood that before using the technical solutions disclosed in the embodiments of the present disclosure, a user should be informed of the type, range of usage, usage scenario, etc. of personal information involved in the present disclosure in an appropriate manner in accordance with relevant laws and regulations, and the authorization of the user should be obtained.

For example, in response to receiving an active request from a user, prompt information is sent to the user to clearly inform the user that the operation requested to be performed will require access to and usage of the user's personal information. In this way, the user may independently choose whether to provide the personal information to software or hardware such as an electronic device, an application, a server, or a storage medium that performs the operation of the technical solution of the present disclosure according to the prompt information.

As an alternative but non-limiting implementation, in response to receiving an active request from the user, the prompt information may be sent to the user in the form of a pop-up window, for example, and the prompt information may be presented in text in the pop-up window. In addition, the pop-up window may further include a selection control for the user to choose whether to "agree" or "disagree" to provide the personal information to the electronic device.

It may be understood that the above process of notifying and acquiring the authorization from the user is merely illustrative and is not intended to limit the implementations of the present disclosure. Other manners that satisfy the requirements of relevant laws and regulations may also be applied to the implementations of the present disclosure.

In addition, it may be understood that the data involved in the technical solution (including but not limited to the data itself, the acquisition of the data, or the usage of the data) should comply with the requirements of corresponding laws, regulations, and related provisions.

As a product of a combination of artificial intelligence and computer technologies, Song Voice Conversion (SVC) music technology is used to generate artificially synthesized singing voices, and it mainly converts singing voice features of one person into singing voice features of another person while retaining information of the original song such as melody and rhythm, which may make the sound of a singer like another singer singing the same song. For example, when an arranger or producer creates a work, the vocal singing part may be supplemented in the manner of SVC, instead of having to seek a real singer to sing, so as to efficiently feel the effect of the work and complete music production. In the SVC music creation process, the Music Source Separation (MSS) technology is usually used to separate different source components from a piece of mixed music, such as extracting vocals, drums, bass, other instruments and other tracks separately, and perform SVC processing on the extracted vocals. However, the audio input to SVC usually has post effects such as harmony, which will affect the quality of the target audio data output from the SVC, lead to poor quality of the audio generated by SVC conversion. Moreover, detection and restoration for the sound quality problem are not integrated in current various sections, which greatly affects the final quality of the target audio data output from the SVC.

Based on this, in the technical solutions of the present disclosure, processing such as harmony separation, removal of post effects such as reverb, and denoising can be added to the audio after the separation of vocal and accompaniment to acquire a purer dry vocal, so that the dry vocal is more in line with technical characteristic of the SVC, thereby effectively improving the quality of audio synthesized by the SVC. In addition, multi-dimensional sound quality detection is added during mixing to achieve sound quality restoration and optimization, thereby improving the quality of the finally generated target audio data.

According to embodiments of the present disclosure, an embodiment of an audio data generation method is provided. It should be noted that the steps shown in the flowcharts of the drawings may be executed in a computer system such as a set of computer executable instructions, and although a logical order is shown in the flowcharts, in certain cases, the steps shown or described may be executed in an order different from that here.

In this embodiment, an audio data generation method is provided, which may be applied to computer devices, such as mobile phones, tablets, computers, etc. FIG. 1 is a flowchart of an audio data generation method according to an embodiment of the present disclosure. As shown in FIG. 1, the flowchart includes the following steps:

Step S101: acquiring original audio data, and separating vocal data and accompaniment data from the original audio data.

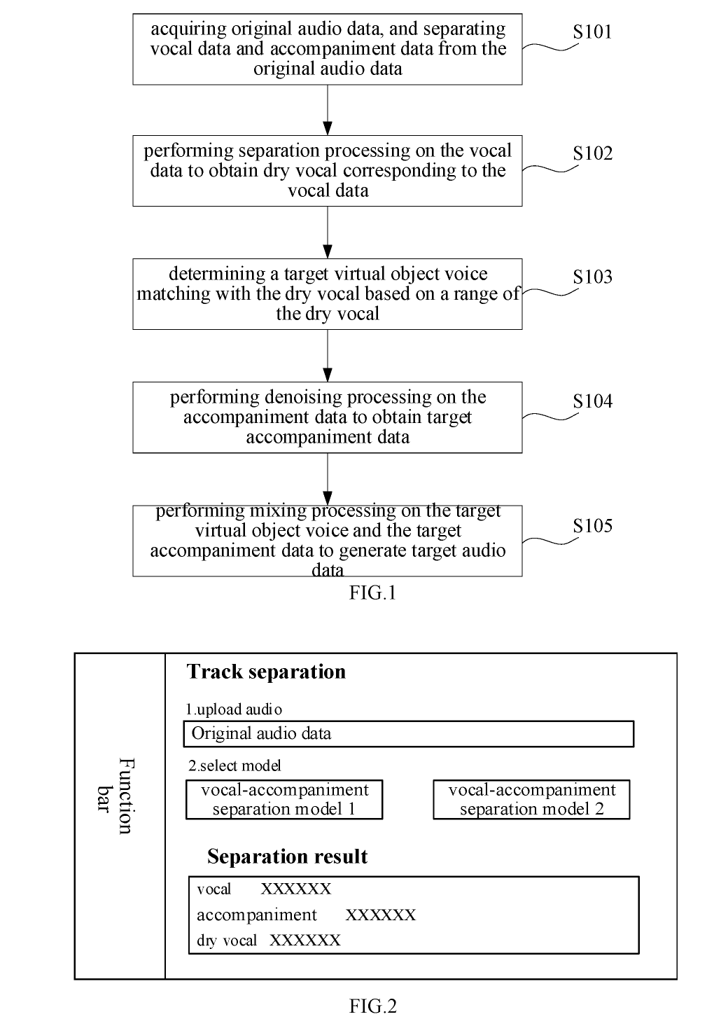

The original audio data is original song audio. Specifically, an audio generation tool is deployed in the computer device, and the audio generation tool provides an interactive interface, as shown in FIG. 2, a user may upload the original audio data through the interactive interface, or may select original audio data of interest from a music library, which is not specifically limited here.

The vocal data is voice data of a song performer; the accompaniment data is data of background music or instrumental music provided for the song, that is, non-vocal data. Specifically, a vocal-accompaniment separation model is deployed in the computer device, the original audio data is input to the vocal-accompaniment model, audio features in the original audio data are extracted by the vocal-accompaniment model, and vocals and accompaniments in the original audio data are separated according to differences between the vocals and the accompaniment in terms of audio features, to obtain corresponding vocal data and accompaniment data, as shown in FIG. 2.

The vocal-accompaniment separation model is a pre-trained model for extracting vocals and accompaniments from audio data. The vocal-accompaniment separation model may be trained based on a machine learning model architecture, may be trained based on a deep learning model architecture, or may be trained based on a convolutional neural network model architecture, which is not specifically limited here, as long as the separation of the vocals and the accompaniments may be realized.

Step S102: performing separation processing on the vocal data to obtain dry vocal corresponding to the vocal data.

The dry vocal is an original vocal recording without any effect processing. However, the above separation of the vocal data and the accompaniment data is only the separation of the vocal data and the non-vocal data, so the vocal data separated from the original audio data may still have harmony, reverb, noise, etc. At this time, audio features such as harmony, reverb and noise in the vocal data may be extracted, so that further separation processing can be performed on the vocal data according to the audio features such as harmony, reverb and noise, to remove the harmony, reverb, noise, etc. existing in the vocal data, to obtain the dry vocal corresponding to the vocal data.

Step S103: determining a target virtual object voice matching with the dry vocal based on a range of the dry vocal.

The range relates to the pitch of the dry vocal, which is used to describe the continuity from the lowest pitch to the highest pitch. The target virtual object voice is an original object voice recording produced when a virtual object sings a song, that is, the dry vocal corresponding to the target virtual object, and different virtual objects have different pitches, such as alto, tenor, contralto, soprano, baritone, etc.

By analyzing the range of the dry vocal, the lowest pitch and the highest pitch of the dry vocal may be determined, so as to match with pitches of different virtual objects in accordance with the lowest pitch and the highest pitch, to determine a target virtual object with the highest matching degree, so that the dry vocal corresponding to the vocal data may be replaced with the voice of the target virtual object to obtain the corresponding target virtual object voice.

Step S104: performing denoising processing on the accompaniment data to obtain target accompaniment data.

Since the noise in the separated accompaniment data will affect the subsequent mixing effect, in order to ensure that the sound quality of the accompaniment data is cleaner and clearer, at this time, the denoising processing may be performed through a denoising model on the accompaniment data to eliminate the noise in the accompaniment data to obtain the corresponding target accompaniment data. The denoising model is a pre-trained model for denoising. The denoising model may be trained based on a machine learning model architecture, or may be trained based on a deep learning model architecture, which is not specifically limited here, as long as the noise removal may be realized.

Step S105: performing mixing processing on the target virtual object voice and the target accompaniment data to generate target audio data.

The target virtual object voice and the target accompaniment data in different audio tracks are mixed according to corresponding audio features, to realize balance and fusion of the target virtual object voice and the target accompaniment data, and parameters such as volume, panning and timbre are adjusted to allow the target virtual object voice and the target accompaniment data to be better fused together to generate the corresponding target audio data.

According to the audio data generation method provided in the embodiment, the vocal data and the accompaniment data are separated from the original audio data, and the separation processing is performed on the vocal data after the separation of the vocal and the accompaniment, to obtain the dry vocal corresponding to the vocal data, so that a purer dry vocal can be acquired, and the dry vocal is more in line with technical characteristics of song voice conversion, thereby effectively improving the quality of audio synthesized by song voice conversion. The target virtual object voice matching with the dry vocal is determined according to the range of the dry vocal, which improves a replacement effect of the target virtual object voice for the dry vocal. Then, the mixing processing is performed on the target virtual object voice and the target accompaniment data obtained by denoising processing to generate the target audio data, so that the target virtual object voice may retain information about the accompaniment data while replacing the dry vocal, thereby improving the quality of the target audio data generation.

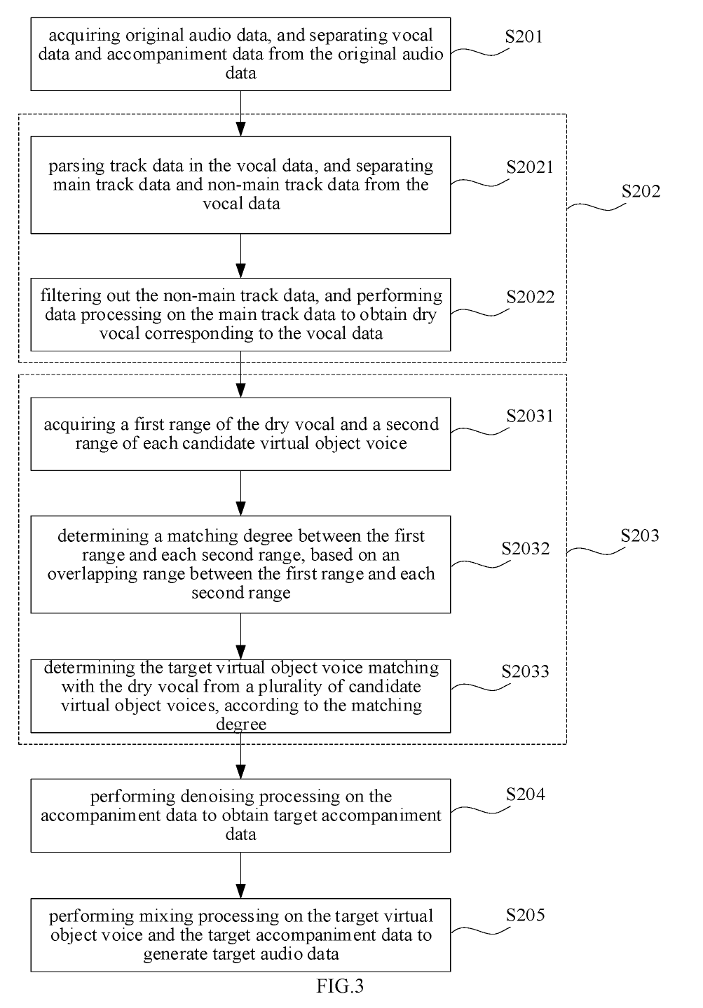

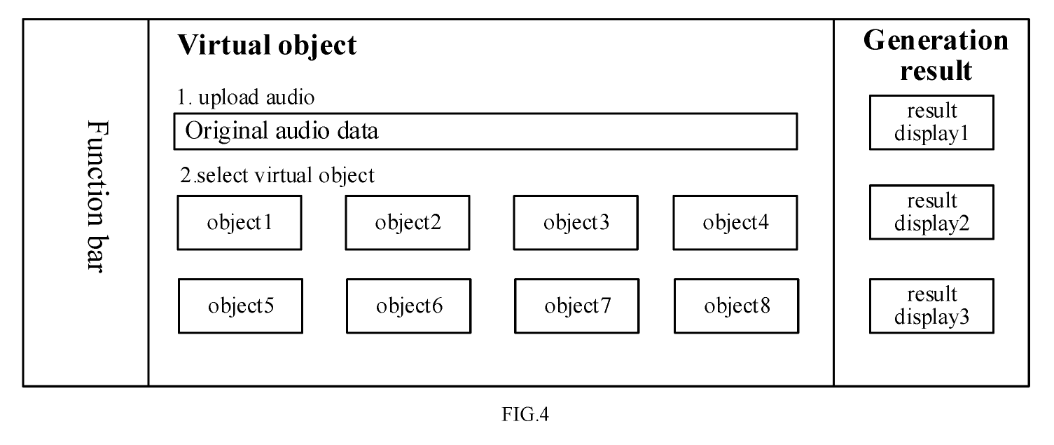

In the embodiment, an audio data generation method is provided, which may be applied to computer devices, such as mobile phones, tablets, computers, etc. FIG. 3 is a flowchart of an audio data generation method according to an embodiment of the present disclosure. As shown in FIG. 3, the process includes the following steps:
Step S201: acquiring original audio data, and separating vocal data and accompaniment data from the original audio data. For details, reference can be made to the relevant description of the corresponding step in the embodiment as discussed above, which will not be repeated here.
Step S202: performing separation processing on the vocal data to obtain dry vocal corresponding to the vocal data.

Specifically, the above step S202 includes:
Step S2021: parsing track data in the vocal data, and separating main track data and non-main track data from the vocal data.

The main track data represents lead vocal data in the vocal data, and the non-main track data represents harmony data in the vocal data. The main track data and the non-main track data correspond to different audio features, and through parsing the audio features of the track data in the vocal data, the main track data and the non-main track data may be separated from the vocal data in conjunction with the difference between the audio features.

In a specific example, a trained harmony separation model may be pre-deployed in the computer device, the vocal data is input to the harmony separation model, and the audio features in the vocal data are parsed by the harmony separation model, and the main track data and the non-main track data can be determined from the vocal data according to the difference between the audio features.

Step S2022: filtering out the non-main track data, and performing data processing on the main track data to obtain dry vocal corresponding to the vocal data.

The non-main track data in the vocal data is filtered out to obtain the main track data in the vocal data, and data such as reverb, echo, delay and noise existing in the main track data is removed to obtain the dry vocal corresponding to the vocal data, and the dry vocal only contains the pure vocal generated during recording.

In some optional implementations, the above step S2022 includes:
Step a1: detecting whether there is audio packaging data in the main track data, wherein the audio packaging data represents a playing effect of the main track data.
Step a2: in response to there being the audio packaging data in the main track data, removing the audio packaging data to obtain first main track data.
Step a3: performing denoising processing on the first main track data to obtain the dry vocal corresponding to the vocal data.

The audio packaging data is data generated by post-packaging the recorded vocals, and the audio packaging data includes effect data such as reverb, echo, delay and equalization, and the playing effect of the main track data is represented by the audio packaging data.

Since there is a relatively large difference in audio between the audio packaging data and the recorded pure vocals, the main track data can be detected according to the difference in audio between the audio packaging data and the pure vocals, to determine whether there is audio packaging data other than the pure vocals in the main track data. If there is audio packaging data other than the pure vocals in the main track data, the audio packaging data carried in the main track data is removed according to a pre-trained effect removal model to obtain relatively pure vocal recording data, that is, the first main track data. Since the first main track data is only vocal recording data, in order to ensure the purity and authenticity of the vocal recording data, a pre-trained denoising model can be further used to remove noise in the first main track data to obtain the pure dry vocal.

It should be noted that the harmony separation model, the effect removal model and the denoising model are connected in series, and the harmony separation model, the effect removal model and the denoising model may be trained based on a machine learning model architecture, or may be trained based on a deep learning model architecture, which is not specifically limited here, as long as the harmony separation function, the effect removal function and the denoising function may be realized.

In an optional implementation, the harmony separation model for realizing the harmony separation function, the effect removal model for realizing the effect removal function and the denoising model for realizing the denoising function may also be integrated in a joint model as sub-models connected in series for training. Therefore, the separated vocal data may be input to the joint model, and the vocal data is successively subjected to harmony separation, effect removal and denoising through the joint model, and the dry vocal corresponding to the vocal data is output.

In the above implementation, since the audio packaging data indicates the post playing effect of the main track data, when it is detected that the audio packaging data exists in the main track data, the audio packaging data can be removed, which realizes the removal of the post effects such as reverb, echo and delay, and avoids the audio packaging data from affecting pronunciation details, thereby ensuring that the dry vocal generated subsequently may retain the original pronunciation details, which is beneficial to the subsequent replacement effect of replacing the dry vocal with the virtual object voice. Meanwhile, the denoising processing can be performed on the main track data, from which the audio packaging data has been removed, to remove noise in the main track data, so as to avoid the noise from interfering with the audio melody, further improve the quality of the dry vocal extraction, and ensure the purity of the extracted dry vocal.

Step S203: determining a target virtual object voice matching with the dry vocal based on a range of the dry vocal.

Specifically, the above step S203 includes:
Step S2031: acquiring a first range of the dry vocal and a second range of each candidate virtual object voice.

The first range represents a pitch range of the dry vocal, that is, the lowest pitch and the highest pitch of the dry vocal. The second range represents a pitch range of the candidate virtual object voice, that is, the lowest pitch and the highest pitch of the candidate virtual object voice.

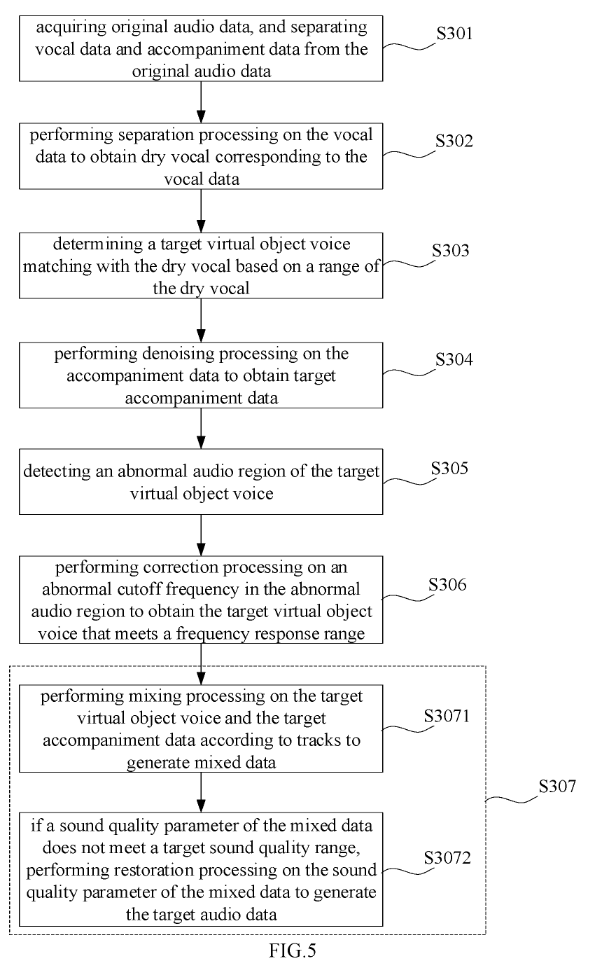

The candidate virtual object voice is the voice recorded by a candidate virtual object selected by the user for a music work. As shown in FIG. 4, the user may select a required candidate virtual object from a virtual object library, employ the candidate virtual object to sing the music work so as to generate the corresponding candidate virtual object voice.

Spectral analysis may be performed on the dry vocal to obtain dry vocal spectral data corresponding to the dry vocal, a lowest frequency point and a highest frequency point can be extracted from the dry vocal spectral data, and the lowest frequency point and the highest frequency point are converted into pitch units to obtain the first range corresponding to the dry vocal. The second range of the candidate virtual object voice may be similarly obtained.

Step S2032: determining a matching degree between the first range and each second range, based on an overlapping range between the first range and each second range.

The first range can be compared to each second range to determine the overlapping range between the first range and each second range. Then the overlapping range is compared with the first range to determine the matching degree between the first range and each second range.

In a specific example, if the first range is [20, 100], the second range is [10, 100], the overlapping range between the first range and the second range is 100 %, that is, the first range completely matches with the second range; if the first range is [20, 100] and the second range is [50, 100], the overlapping range between the first range and the second range is [50, 100], and the matching degree between the first range and the second range is 50/80=62.5 %.

Step S2033: determining the target virtual object voice matching with the dry vocal from a plurality of candidate virtual object voices, according to the matching degree.

Each matching degree is compared with a preset matching degree to determine whether each matching degree exceeds the preset matching degree, where the preset matching degree is the lowest matching degree at which the dry vocal and the virtual object voice may match. The matching degrees are sorted to obtain a matching degree sorting result, the highest matching degree is selected from the matching degree sorting result, and the candidate virtual object voice corresponding to the highest matching degree is determined as the target virtual object voice.

It should be noted that if the highest matching degree corresponds to a plurality of candidate virtual object voices, one candidate virtual object voice may be randomly selected from the candidate virtual object voices as the target virtual object voice; or the plurality of candidate virtual object voices may be presented to the user, so that the user may select a candidate virtual object voice of interest as the target virtual object voice. Certainly, the target virtual object voice may also be selected from the plurality of candidate virtual object voices in other ways, which is not specifically limited here.

Step S204: performing denoising processing on the accompaniment data to obtain target accompaniment data. For details, reference can be made to the relevant description of the corresponding step in the embodiment as discussed above, which will not be repeated here.

Step S205: performing mixing processing on the target virtual object voice and the target accompaniment data to generate target audio data. For details, reference can be made to the relevant description of the corresponding step in the embodiment as discussed above, which will not be repeated here.

According to the audio data generation method provided in the embodiment, the track data in the vocal data is parsed to separate the vocal data into the main track data and the non-main track data, and the non-main track data is filtered out to avoid the interference of the non-main track data on the identification of the pure dry vocal, so that the pure dry vocal may be extracted from the main track data, thereby improving the identification accuracy and identification efficiency of the dry vocal. The overlapping range between the dry vocal and the candidate virtual object voice is determined by comparing the range of the dry vocal and the range of the candidate virtual object voice, so that the matching degree in the range between the dry vocal and each candidate virtual object voice may be determined in conjunction with the overlapping range, so as to determine the target virtual object voice matching with the dry vocal according to the matching degree, therefore, the target virtual object voice that may replace the dry vocal may be selected from the candidate virtual object voices, thereby ensuring that the target virtual object voice may conform to the audio features of the dry vocal, improving the conversion effect of the target virtual object voice for the dry vocal, and thus improving the quality of synthesis of the target audio data by using the target virtual object voice.

In embodiments, an audio data generation method is provided, which may be applied to computer devices, such as mobile phones, tablets, computers, etc. FIG. 5 is a flowchart of an audio data generation method according to an embodiment of the present disclosure. As shown in FIG. 5, the process includes the following steps:
Step S301: acquiring original audio data, and separating vocal data and accompaniment data from the original audio data. For details, reference can be made to the relevant description of the corresponding step in the embodiment as discussed above, which will not be repeated here.
Step S302: performing separation processing on the vocal data to obtain dry vocal corresponding to the vocal data. For details, reference can be made to the relevant description of the corresponding step in the embodiment as discussed above, which will not be repeated here.
Step S303: determining a target virtual object voice matching with the dry vocal based on a range of the dry vocal. For details, reference can be made to the relevant description of the corresponding step in the embodiment as discussed above, which will not be repeated here.
Step S304: performing denoising processing on the accompaniment data to obtain target accompaniment data. For details, reference can be made to the relevant description of the corresponding step in the embodiment as discussed above, which will not be repeated here.
Step S305: detecting an abnormal audio region of the target virtual object voice.

The abnormal audio region is a region where an abnormal cutoff frequency existing in the target virtual object voice is located, and the cutoff frequency refers to a frequency corresponding to a signal amplitude dropping to 0.707 times a maximum value in the audio signal processing process, and the cutoff frequency is a boundary frequency, which is used to divide a frequency range in which the audio signal may effectively pass and a frequency range in which the audio signal be significantly attenuated.

An audio signal of the target virtual object voice can be processed to determine a signal amplitude of the audio signal. The abnormal cutoff frequency of the target virtual object voice can be identified according to the signal amplitude to determine the abnormal audio region existing in the target virtual object voice.

Step S306: performing correction processing on an abnormal cutoff frequency in the abnormal audio region to obtain the target virtual object voice that meets a frequency response range.

The frequency response range is a frequency range through which the audio signal is ensured to effectively pass. When the abnormal audio region in the audio signal is identified, the abnormal cutoff frequency in the abnormal audio region is corrected to adjust the signal amplitude of the audio signal corresponding to the abnormal cutoff frequency to an appropriate frequency response range, so that the target virtual object voice may meet the frequency response range.

Step S307: performing mixing processing on the target virtual object voice and the target accompaniment data to generate target audio data.

Specifically, the above step S307 includes:
Step S3071: performing mixing processing on the target virtual object voice and the target accompaniment data according to tracks to generate mixed data.

The target virtual object voice and the target accompaniment data have corresponding tracks, and the target virtual object voice is in the main track. In order to ensure that the target accompaniment data may be fused with the main track in terms of audio data, the pitch of the target accompaniment data is adjusted so that the target accompaniment data produces a harmonious interval with the target virtual object voice in the main track, and can be added audio packaging effects such as delay, reverb and compression, meanwhile, an equalizer is adjusted to change a frequency response to enhance or reduce certain frequencies of the target accompaniment data, and compression, a limiter or a gate can be used to change the dynamic range of the target accompaniment data. Then, the adjusted target accompaniment data and the target virtual object voice in the main track are mixed together to obtain the mixed data.

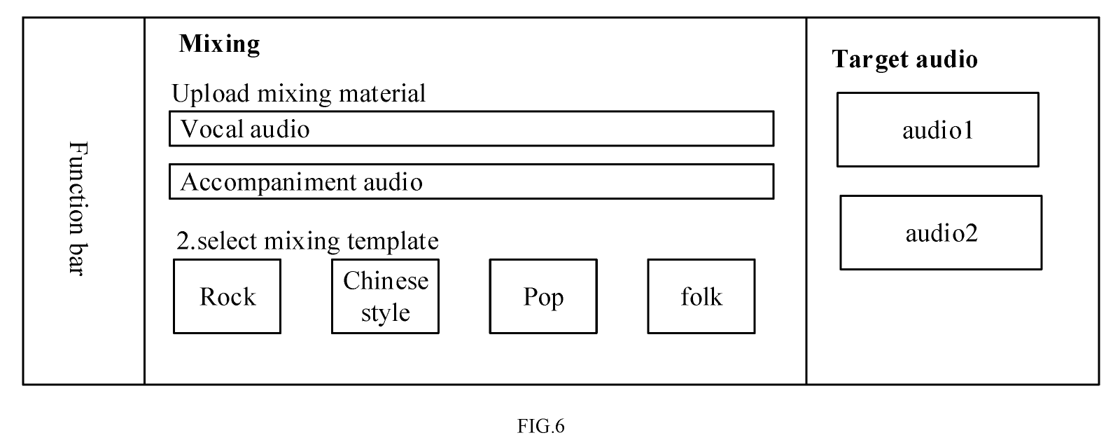

In an optional implementation, as shown in FIG. 6, the user may select a mixing template, and different mixing templates have different mixing modes, such as Chinese style mixing mode, rock mixing mode, pop mixing mode, etc. The mixing processing can be performed on the target virtual object voice and the target accompaniment data according to the mixing mode of the mixing template to generate the corresponding mixed data.

Step S3072: if a sound quality parameter of the mixed data does not meet a target sound quality range, performing restoration processing on the sound quality parameter of the mixed data to generate the target audio data.

The sound quality parameter represents a sound quality effect of the mixed data, and different sound quality parameters have different target sound quality ranges. Specifically, a sound quality detection tool may be pre-deployed in the computer device, and the sound quality detection is performed on the mixed data by the sound quality detection tool to determine whether the sound quality parameter of the mixed data meets a corresponding target sound quality range. If it is determined that the sound quality parameter of the mixed data does not meet the target sound quality range, the sound quality parameter of the mixed data is restored to obtain the target audio data whose sound quality parameter meets the target sound quality range.

In some optional implementations, the sound quality parameter includes a clipping rate and loudness, where the clipping rate refers to a clipping degree applied when an audio signal exceeds a maximum processable level. When the audio signal reaches or exceeds a maximum output level, clipping will occur, resulting in the signal waveform being truncated, thus producing distortion. The loudness represents the sound intensity of the audio, and if the loudness exceeds a specified volume limit, it is easy to cause hearing damage; if the loudness is insufficient, it will lead to loss of details and poor hearing experience. Moreover, the loudness imbalance occurs between different audio segments and will also affect the sound quality and the user's listening experience.

Correspondingly, the above step S3072 includes:
Step b1: detecting clipped audio data corresponding to the clipping rate, and performing reconstruction and restoration processing on the clipped audio data to generate audio reconstructed data.

An audio signal amplitude of the mixed data is detected to determine an audio waveform corresponding to the audio signal amplitude. For audio points (i.e., clipping points) in the audio waveform exceeding the maximum output level, the clipping rate can be obtained by counting a proportion of the clipping points in the total mixing duration.

A clipping region of the mixed data is determined according to the clipping rate, and the clipped audio data is extracted from the clipping region, the clipped audio data in the clipping region is restored to restore the integrity and dynamic range of the mixed data, thereby ensuring that the mixed data will not have popping and stuttering during playback. In some specific implementations, unclipped audio data may be searched before and after the clipping points, and these audio data may be spliced to achieve clipping removal; the audio data may also be expanded before or after the clipping points to fill the clipping region; interpolation techniques (such as linear interpolation) may also be used to fill the clipping region, etc., and the processing for the clipped audio data is not specifically limited here. Then, a dynamic processing tool (such as a compressor, a limiter) is used to restore the dynamic range of the audio signal to reduce the influence of the clipped audio data on the audio quality.

Step b2: restoring loudness of the audio reconstructed data to generate target audio data that meets a loudness range.

An audio signal with excessive loudness in the audio reconstructed data can be compressed, and an audio signal with insufficient loudness is expanded to ensure that the loudness of all audio signals is within the loudness range, so as to obtain the corresponding target audio data.

In a specific example, a mastering technique can be used to compress and expand dynamic ranges of the audio signals in the audio reconstructed data, so that the loudness of all audio signals follows the loudness range (for example, keeping the loudness in a range as much as possible within -5dB). In this way, an intelligent improvement of the overall level of the audio signal can be realized, while avoiding the sound quality loss caused by excessive compression, and ensuring that audio details in the audio signal can be retained.

In the above implementation, the reconstruction and restoration processing is performed on the clipped audio data to generate the audio reconstructed data, so as to ensure the integrity and dynamic range of the audio signal of the audio reconstructed data, and ensure that the audio signal of the audio reconstructed data will not have popping and stuttering during playback. The loudness of the audio reconstructed data is restored to generate the target audio data that meets the loudness range, so as to ensure that the loudness of all audio signals of the target audio data is within the loudness range, ensure that the audio details in all audio signals of the target audio data are retained, thereby improving the generation effect of the target audio data.

In some optional implementations, the sound quality parameter may include an abnormal cutoff frequency, and before step b2, the above method may further include:
identifying the abnormal cutoff frequency of the audio reconstructed data, and restoring the abnormal cutoff frequency to generate the audio reconstructed data that meets a frequency response range.

An audio signal of the audio reconstructed data can be processed to determine an audio signal amplitude of the audio reconstructed data. The abnormal cutoff frequency of the audio reconstructed data can be detected and identified according to the audio signal amplitude to determine whether the audio signal of the audio reconstructed data has an abnormal cutoff frequency.

The frequency response range is a frequency range through which the audio signal is ensured to effectively pass. When it is identified that the abnormal cutoff frequency exists in the audio signal of the audio reconstructed data, the correction and restoration can be performed on the abnormal cutoff frequency to adjust the audio signal amplitude of the audio reconstructed data to an appropriate frequency response range, thereby ensuring that the audio signal of the audio reconstructed data meets the frequency response range.

In the above implementation, the correction and restoration can be performed on the abnormal cutoff frequency of the audio reconstructed data to ensure that the response characteristic of the audio signal of the audio reconstructed data in the entire frequency range meets the high-quality audio standard, and the sound brightness and transparency of the audio reconstructed data can be effectively improved, thereby ensuring the brightness and transparency of the subsequent target audio data in the playback process, and improving the playback effect of the target audio data.

According to the audio data generation method provided in the embodiment, before the mixing processing is performed on the target virtual object voice and the target accompaniment data, the correction processing is performed on the abnormal cutoff frequency to improve the audio quality of the target virtual object voice, meanwhile, it is ensured that the target virtual object voice presents fuller and rounder characteristics in the high-frequency region, thereby effectively improving the brightness and transparency of the sound. The mixing processing is performed on the target virtual object voice and the target accompaniment data according to the tracks, and the sound quality detection is performed on the mixing processing to perform the restoration processing on the sound quality parameter that does not meet the target sound quality range, thereby realizing optimization of the sound quality parameter, effectively improving the generation quality of the target audio data, and being beneficial to improving the listening experience of the target audio data.

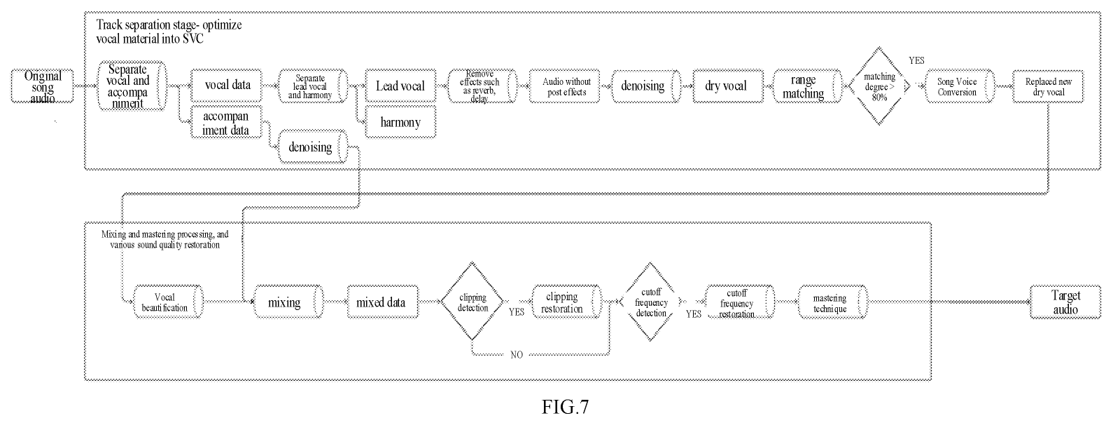

As a specific application implementation of the embodiments of the present disclosure, as shown in FIG. 7, the original song audio is input to a vocal-accompaniment separation model, and the vocal-accompaniment separation is performed through the vocal-accompaniment separation model to obtain vocal data and accompaniment data; the harmony separation is performed on the vocal data through a harmony separation model to obtain lead vocal data (i.e., main track data) and harmony (non-main track data) of the song; and the effects such as reverb, echo and delay in the lead vocal data are removed by an effect removal model, and the noise is removed by a denoising model, to obtain a purer dry vocal than the vocal-accompaniment separation model.

A range matching mode is used to detect whether a range of the dry vocal matches with a range of a virtual singer (i.e., a virtual object voice), and if the matching degree is greater than 80 %, the final dry vocal is input to the virtual singer for song voice conversion to obtain a new vocal after SVC.

The denoising processing is performed on the accompaniment data to make the sound quality of the accompaniment data cleaner and clearer, and enhance the overall hearing experience of the accompaniment data. The new vocal after SVC is beautified to make the vocal present fuller and rounder characteristics in the high-frequency region, thereby effectively improving the brightness and transparency of the sound. Meanwhile, through the intelligent identification and correction for the abnormal cutoff frequency, it is ensured that the response characteristic of the vocal in the entire frequency range meets the high-quality audio standard.

The clipped audio data of the mixed data is detected, and the clipped audio data is reconstructed and restored to restore the integrity and dynamic range of the audio signal of the mixed data, thereby ensuring that the audio signal of the mixed data will not have popping and stuttering during playback.

The abnormal cutoff frequency of the mixed data is detected, and the abnormal cutoff frequency of the mixed data is identified and corrected to ensure that the response characteristic of the mixed data in the entire frequency range meets the high-quality audio standard.

Through intelligent mastering techniques, on the premise of following the loudness standard (for example, keeping the loudness in a range as large as possible within -5dB), the dynamic range of the audio signal of the mixed data is compressed and expanded to improve the overall level of the audio signal, while avoiding the sound quality loss caused by excessive compression, and ensuring that audio details are retained, thereby realizing the loudness restoration of the mixed data.

In embodiments, an audio data generation apparatus is further provided, and the apparatus can be used to implement the above embodiments and preferred implementations, which will not be repeated here. As used below, the term "module" may indicate a combination of software and/or hardware for implementing a predetermined function. Although the apparatus described in the following embodiments is preferably implemented in software, implementation in hardware, or a combination of software and hardware may be also possible and contemplated.

An embodiment provides an audio data generation apparatus, as shown in FIG. 8, including:
an acquisition module 401, configured to acquire original audio data, and separate vocal data and accompaniment data from the original audio data;
a separation module 402, configured to perform separation processing on the vocal data to obtain a dry vocal corresponding to the vocal data;
a matching module 403, configured to determine a target virtual object voice matching with the dry vocal based on a range of the dry vocal;
a denoising module 404, configured to perform denoising processing on the accompaniment data to obtain target accompaniment data;
and a generation module 405, configured to perform mixing processing on the target virtual object voice and the target accompaniment data to generate target audio data.

In some optional implementations, the separation module 402 includes:
a parsing unit, configured to parse track data in the vocal data to separate main track data and non-main track data from the vocal data; and
a data processing unit, configured to filter out the non-main track data, and perform data processing on the main track data to obtain the dry vocal corresponding to the vocal data.

In some optional implementations, the data processing unit includes:
a detection sub-unit, configured to detect whether there is audio packaging data in the main track data, where the audio packaging data represents a playback effect of the main track data;
a data removing sub-unit, configured to remove the audio packaging data to obtain first main track data, if there is the audio packaging data in the main track data; and
a data denoising sub-unit, configured to perform denoising processing on the first main track data to obtain the dry vocal corresponding to the vocal data.

In some optional implementations, the matching module 403 includes:
a range acquisition unit, configured to acquire a first range of the dry vocal and a second range of each candidate virtual object voice;
a range matching unit, configured to determine a matching degree between the first range and each second range, based on an overlapping range between the first range and each second range; and
a target determination unit, configured to determine the target virtual object voice matching with the dry vocal from a plurality of candidate virtual object voices, according to the matching degree.

In some optional implementations, the above apparatus further includes:
an abnormal audio detection module, configured to detect an abnormal audio region of the target virtual object voice; and
a correction module, configured to perform correction processing on an abnormal cutoff frequency in the abnormal audio region to obtain the target virtual object voice that meets a frequency response range.

In some optional implementations, the generation module 405 includes:
a mixing unit, configured to perform mixing processing on the target virtual object voice and the target accompaniment data according to a track to generate mixed data; and
a restoration unit, configured to perform restoration processing on a sound quality parameter of the mixed data to generate the target audio data, if the sound quality parameter of the mixed data does not meet a target sound quality range.

In some optional implementations, the sound quality parameter includes a clipping rate and loudness, and correspondingly, the restoration unit includes:
a clipping restoration sub-unit, configured to detect clipping audio data corresponding to the clipping rate, and perform reconstruction and restoration processing on the clipping audio data to generate audio reconstructed data; and
a loudness restoration sub-unit, configured to restore the loudness of the audio reconstructed data to generate target audio data that meets a loudness range.

In some optional implementations, the sound quality parameter includes an abnormal cutoff frequency, and the restoration unit further includes:
a cutoff frequency restoration sub-unit, configured to identify the abnormal cutoff frequency of the audio reconstructed data, and restore the abnormal cutoff frequency to generate audio reconstructed data that meets a frequency response range.

Further functional descriptions of the above modules and units are the same as those in the corresponding embodiments above, and will not be repeated here.

The audio data generation apparatus in this embodiment is presented in the form of functional units, and the unit here refers to an application specific integrated circuit (ASIC) circuit, a processor and a memory that execute one or more software or fixed programs, and/or other devices that may provide the above functions.

According to the audio data generation apparatus provided in this embodiment, the vocal data and the accompaniment data are separated from the original audio data, and the separation processing is performed on the vocal data after the separation of the vocal and the accompaniment, to obtain the dry vocal corresponding to the vocal data, so that a purer dry vocal can be acquired, and the dry vocal is more in line with technical characteristics of song voice conversion, thereby effectively improving the quality of audio synthesized by song voice conversion. The target virtual object voice matching with the dry vocal is determined according to the range of the dry vocal, which improves a replacement effect of the target virtual object voice for the dry vocal. Then, the mixing processing is performed on the target virtual object voice and the target accompaniment data obtained by denoising processing to generate the target audio data, so that the target virtual object voice may retain information about the accompaniment data while replacing the dry vocal, thereby improving the quality of the target audio data generation.

An embodiment of the present disclosure further provides a computer device having the audio data generation apparatus shown in FIG. 8 above.

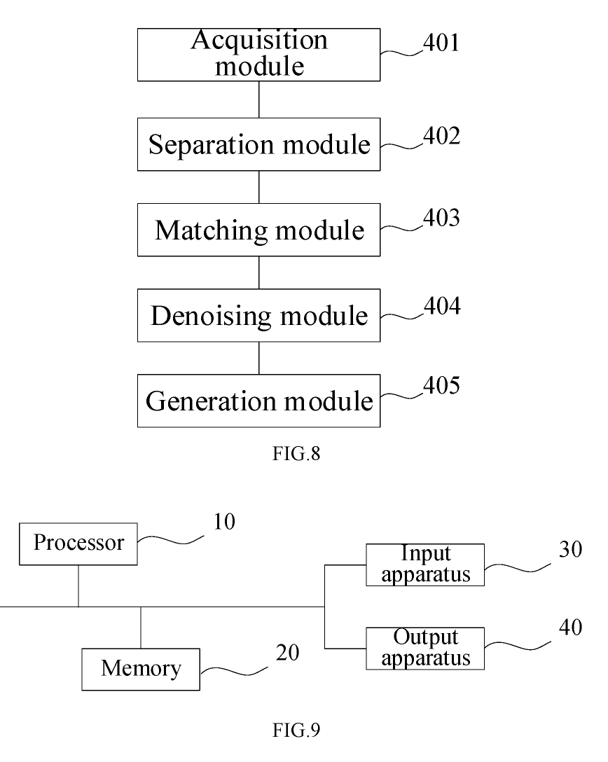

Please refer to FIG. 9. FIG. 9 is a schematic structural diagram of a computer device provided by an optional embodiment of the present disclosure. As shown in FIG. 9, the computer device includes:
one or more processors 10, a memory 20, and interfaces for connecting various components, including high-speed interfaces and low-speed interfaces. The components communicate with each other using different buses and may be installed on a common main board or in other ways as needed. The processor may process instructions executed within the computer device, including instructions stored in or on the memory to display graphical information of GUI on an external input/output apparatus (such as a display device coupled to the interface). In some optional implementations, if required, multiple processors and/or buses may be used with multiple memories and multiple memories. Similarly, multiple computer devices may be connected, and each device provides some necessary operations (for example, as a server array, a group of blade servers, or a multi-processor system). In FIG. 9, one processor 10 is taken as an example.

The processor 10 may be a central processing unit, a network processor or a combination thereof. The processor 10 may further include a hardware chip. The hardware chip may be an application specific integrated circuit, a programmable logic device or a combination thereof. The programmable logic device may be a complex programmable logic device, a field programmable logic gate array, a generic array logic, or any combination thereof.

The memory 20 stores instructions executable by at least one processor 10, so that the at least one processor 10 executes the method shown in the above embodiments.

The memory 20 may include a program storage area and a data storage area, where the program storage area may store an operating system and an application program required by at least one function; the data storage area may store data created according to the use of the computer device, etc. In addition, the memory 20 may include a high-speed random-access memory or a non-transitory memory, such as at least one magnetic disk storage device, a flash memory device, or other non-transitory solid-state storage devices. In some optional implementations, the memory 20 optionally includes memories remotely provided with respect to the processor 10, and these remote memories may be connected to the computer device through a network. Examples of the above network include, but are not limited to, Internet, an intranet, a local area network, a mobile communication network, and a combination thereof.

The memory 20 may include a volatile memory, such as a random-access memory; the memory may also include a non-volatile memory, such as a flash memory, a hard disk or a solid-state disk; the memory 20 may also include a combination of the above kinds of memories.

The computer device further includes an input apparatus 30 and an output apparatus 40. The processor 10, the memory 20, the input apparatus 30 and the output apparatus 40 may be connected through a bus or in other ways. In FIG. 9, connection through a bus is taken as an example.

The input apparatus 30 may receive input digital or character information, and generate a key signal input related to user settings and function control of the computer device, such as a touch screen, a keypad, a mouse, a track pad, a touch panel, an indicator stick, one or more mouse buttons, a trackball, a joystick, etc. The output apparatus 40 may include a display device, an auxiliary lighting apparatus (such as an LED), a tactile feedback apparatus (such as a vibration motor), etc. The above display device includes, but is not limited to, a liquid crystal display, a light emitting diode, a display, and a plasma display. In some optional implementations, the display device may be a touch screen.

The computer device further includes a communication interface for the computer device to communicate with other devices or communication networks.

An embodiment of the present disclosure further provides a computer-readable storage medium, and the method according to the embodiments of the present disclosure may be implemented in hardware and firmware, or implemented as a computer code that may be recorded in a storage medium or originally stored in a remote storage medium or a non-transitory machine-readable storage medium and downloaded through a network and will be stored in a local storage medium, so that the method described herein may be stored in such software processing on a storage medium using a general-purpose computer, a dedicated processor, or programmable or dedicated hardware. The storage medium may be a magnetic disk, an optical disk, a read-only memory, a random-access memory, a flash memory, a hard disk or a solid-state disk, etc. Further, the storage medium may also include a combination of the above kinds of memories. It may be understood that the computer, the processor, the microprocessor controller or the programmable hardware includes a storage component that may store or receive software or computer code, and when the software or computer code is accessed and executed by the computer, the processor or the hardware, the method shown in the above embodiments is implemented.

A part of the present disclosure may be applied as a computer program product, such as computer program instructions, which, when executed by a computer, may invoke or provide the method and/or technical solutions according to the present disclosure through the operation of the computer. Those skilled in the art should understand that the computer program instructions exist in the computer-readable medium in forms including, but not limited to, a source file, an executable file, an installation package file, etc. Correspondingly, the computer program instructions are executed by the computer in manners including, but not limited to:
the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium accessible by the computer.

Although the embodiments of the present disclosure are described in combination with the drawings, those skilled in the art may make various modifications and variations without departing from the spirit and scope of the present disclosure, and such modifications and variations all fall within the scope defined by the appended claims.

What is claimed is:

1. An audio data generation method, comprising:
acquiring original audio data, and separating vocal data and accompaniment data from the original audio data;
performing separation processing on the vocal data to obtain a dry vocal corresponding to the vocal data;
determining a target virtual object voice matching with the dry vocal based on a range of the dry vocal;
performing denoising processing on the accompaniment data to obtain target accompaniment data; and
performing mixing processing on the target virtual object voice and the target accompaniment data to generate target audio data.

2. The method of claim 1, wherein the performing separation processing on the vocal data to obtain the dry vocal corresponding to the vocal data comprises:
parsing track data in the vocal data to separate main track data and non-main track data from the vocal data; and
filtering out the non-main track data, and performing data processing on the main track data to obtain the dry vocal corresponding to the vocal data.

3. The method of claim 2, wherein the performing data processing on the main track data to obtain the dry vocal corresponding to the vocal data, comprises:
detecting whether there is audio packaging data in the main track data, wherein the audio packaging data is used to represent a playback effect of the main track data;
in response to there being the audio packaging data in the main track data, removing the audio packaging data to obtain first main track data; and
performing denoising processing on the first main track data to obtain the dry vocal corresponding to the vocal data.

4. The method of claim 1, wherein the determining the target virtual object voice matching with the dry vocal based on the range of the dry vocal comprises:
acquiring a first range of the dry vocal and a second range of each candidate virtual object voice;
determining a matching degree between the first range and each second range based on an overlapping range between the first range and each second range; and
determining the target virtual object voice matching with the dry vocal from a plurality of candidate virtual object voices, according to the matching degree.

5. The method of claim 1, wherein before the performing mixing processing on the target virtual object voice and the target accompaniment data, the method further comprises:
detecting an abnormal audio region of the target virtual object voice; and
performing correction processing on an abnormal cutoff frequency in the abnormal audio region to obtain the target virtual object voice that meets a frequency response range.

6. The method of claim 1, wherein the performing mixing processing on the target virtual object voice and the target accompaniment data to generate the target audio data, comprises:
performing mixing processing on the target virtual object voice and the target accompaniment data according to a track to generate mixed data; and
in response to a sound quality parameter of the mixed data not meeting a target sound quality range, performing restoration processing on the sound quality parameter of the mixed data to generate the target audio data.

7. The method of claim 6, wherein the sound quality parameter comprises a clipping rate and loudness; wherein the performing restoration processing on the sound quality parameter of the mixed data to generate the target audio data, comprises:
detecting clipped audio data corresponding to the clipping rate, and performing reconstruction and restoration processing on the clipped audio data to generate audio reconstructed data; and
restoring the loudness of the audio reconstructed data to generate the target audio data that meets a loudness range.

8. The method of claim 7, wherein the sound quality parameter comprises an abnormal cutoff frequency; wherein, before the restoring the loudness of the audio reconstructed data to generate the target audio data that meets the loudness range, the method further comprises:
identifying the abnormal cutoff frequency of the audio reconstructed data, and restoring the abnormal cutoff frequency to generate the audio reconstructed data that meets a frequency response range.

9. A computer device, comprising:
a memory and a processor, the memory storing computer instructions, and the processor executes the computer instructions to perform:
performing separation processing on the vocal data to obtain a dry vocal corresponding to the vocal data;
determining a target virtual object voice matching with the dry vocal based on a range of the dry vocal;
performing denoising processing on the accompaniment data to obtain target accompaniment data; and
performing mixing processing on the target virtual object voice and the target accompaniment data to generate target audio data.

10. The computer device of claim 9, wherein the performing separation processing on the vocal data to obtain the dry vocal corresponding to the vocal data comprises:
parsing track data in the vocal data to separate main track data and non-main track data from the vocal data; and
filtering out the non-main track data, and performing data processing on the main track data to obtain the dry vocal corresponding to the vocal data.

11. The computer device of claim 10, wherein the performing data processing on the main track data to obtain the dry vocal corresponding to the vocal data, comprises:
detecting whether there is audio packaging data in the main track data, wherein the audio packaging data is used to represent a playback effect of the main track data;
in response to there being the audio packaging data in the main track data, removing the audio packaging data to obtain first main track data; and
performing denoising processing on the first main track data to obtain the dry vocal corresponding to the vocal data.

12. The computer device of claim 9, wherein the determining the target virtual object voice matching with the dry vocal based on the range of the dry vocal comprises:
acquiring a first range of the dry vocal and a second range of each candidate virtual object voice;
determining a matching degree between the first range and each second range based on an overlapping range between the first range and each second range; and
determining the target virtual object voice matching with the dry vocal from a plurality of candidate virtual object voices, according to the matching degree.

13. The computer device of claim 9, wherein before the performing mixing processing on the target virtual object voice and the target accompaniment data, the processor executes the computer instructions to further perform:
detecting an abnormal audio region of the target virtual object voice; and
performing correction processing on an abnormal cutoff frequency in the abnormal audio region to obtain the target virtual object voice that meets a frequency response range.

14. The computer device of claim 9, wherein the performing mixing processing on the target virtual object voice and the target accompaniment data to generate the target audio data, comprises:
performing mixing processing on the target virtual object voice and the target accompaniment data according to a track to generate mixed data; and
in response to a sound quality parameter of the mixed data not meeting a target sound quality range, performing restoration processing on the sound quality parameter of the mixed data to generate the target audio data.

15. A non-transitory computer-readable storage medium, wherein the computer-readable storage medium stores computer instructions thereon, wherein the computer instructions, when executed by a processor, cause the processor to perform:
performing separation processing on the vocal data to obtain a dry vocal corresponding to the vocal data;
determining a target virtual object voice matching with the dry vocal based on a range of the dry vocal;
performing denoising processing on the accompaniment data to obtain target accompaniment data; and
performing mixing processing on the target virtual object voice and the target accompaniment data to generate target audio data.

16. The non-transitory computer-readable storage medium of claim 15, wherein the performing separation processing on the vocal data to obtain the dry vocal corresponding to the vocal data comprises:
parsing track data in the vocal data to separate main track data and non-main track data from the vocal data; and
filtering out the non-main track data, and performing data processing on the main track data to obtain the dry vocal corresponding to the vocal data.

17. The non-transitory computer-readable storage medium of claim 16, wherein the performing data processing on the main track data to obtain the dry vocal corresponding to the vocal data, comprises:
detecting whether there is audio packaging data in the main track data, wherein the audio packaging data is used to represent a playback effect of the main track data;
in response to there being the audio packaging data in the main track data, removing the audio packaging data to obtain first main track data; and
performing denoising processing on the first main track data to obtain the dry vocal corresponding to the vocal data.

18. The non-transitory computer-readable storage medium of claim 15, wherein the determining the target virtual object voice matching with the dry vocal based on the range of the dry vocal comprises:
acquiring a first range of the dry vocal and a second range of each candidate virtual object voice;
determining a matching degree between the first range and each second range based on an overlapping range between the first range and each second range; and
determining the target virtual object voice matching with the dry vocal from a plurality of candidate virtual object voices, according to the matching degree.

19. The non-transitory computer-readable storage medium of claim 15, wherein before the performing mixing processing on the target virtual object voice and the target accompaniment data, the computer instructions, when executed by a processor, cause the processor to perform:
detecting an abnormal audio region of the target virtual object voice; and
performing correction processing on an abnormal cutoff frequency in the abnormal audio region to obtain the target virtual object voice that meets a frequency response range.

20. The non-transitory computer-readable storage medium of claim 15, wherein the performing mixing processing on the target virtual object voice and the target accompaniment data to generate the target audio data, comprises:
performing mixing processing on the target virtual object voice and the target accompaniment data according to a track to generate mixed data; and
in response to a sound quality parameter of the mixed data not meeting a target sound quality range, performing restoration processing on the sound quality parameter of the mixed data to generate the target audio data.
